(19) United States
(12) Patent Application Publication
(10) Pub. No.: US 2003/0020356 A1
(43) Pub. Date: Jan. 30, 2003

(54) Pole plate structure for a motor stator

(75) Inventors: Alex Horng, Kaohsiung (TW); Ching-Shen Hong, Kaohsiung (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 09/912,516

(22) Filed: Jul. 26, 2001

(51) Int. Cl. H02K 1/12

(52) U.S. Cl. 310/216; 310/257

(57) ABSTRACT

A stator comprises a bobbin around which a winding is mounted. Pole plates are respectively mounted to two ends of the bobbin. Each pole plate comprises a plurality of vertically extending pole faces each having a peak region and two sides. The peak region is not located on a central line passing through a middle point on a bottom side of the respective pole face and being perpendicular to the respective pole plate; namely, the peak region is located on a side of the central line. The two sides of the respective pole face that connect the bottom side of the respective pole face to the peak region are non-rectilinear and different from each other in shape.

### BACKGROUND OF THE INVENTION

1. Field of the Invention

The present invention relates to a pole plate structure for a motor stator. More particularly, the present invention relates to a pole plate structure for a brushless d.c. motor stator that increases the rotating torque of the motor while allowing easy starting of the motor and reducing the cogging torque.

2. Description of the Related Art

A conventional cooling fan motor, as illustrated in FIGS. 1 and 2 of the drawings, discloses a stator for a brushless d.c. motor comprising an upper pole plate 91 and a lower pole plate 92 respectively mounted to upper and lower ends of a set of winding 93. Each pole plate 91, 92 comprises a plurality of vertically extending magnetic pole faces 94 for increasing a rotating torque of the rotor. In order to allow easy starting and avoid dead corner in rotation of the rotor, each magnetic pole face 94 includes a chamfered corner 95. However, since the permanent magnet of the rotor is comprised of alternatively disposed north poles and south poles and since the rotor is driven by the alternating magnetic fields generated by the stator winding, an effect of changing in the rotating torque or uneven rotating torque (the so-called “cogging torque”) occurs during a transient change between the north pole and south pole of the permanent magnet of the rotor relative to the magnetic pole faces of the upper and lower pole plates 91 and 92. As illustrated in FIGS. 1 and 2, at least an edge 96 of the magnetic pole face 94 represents a rectilinear line that is perpendicular to a general plane of the pole plate 91, 92, which generates a significant cogging torque during rotation of the rotor. Trembling of the rotor as a result of cogging torque is more obvious when the rotor rotates at low speed.

### SUMMARY OF THE INVENTION

An object of the present invention is to provide a pole plate structure for a motor stator having a larger relative induction area between the rotor and the stator magnetic poles to thereby increase the rotating torque of the rotor. In addition, the pole plate structure allows easy starting of the rotor and reduces the cogging torque during rotation of the rotor.

A stator in accordance with the present invention comprises a bobbin around which a winding is mounted. Pole plates are respectively mounted to two ends of the bobbin. Each pole plate comprises a plurality of vertically extending pole faces each having a peak region and two sides. The peak region is not located on a central line passing through a middle point on a bottom side of the respective pole face and being perpendicular to the respective pole plate; namely, the peak region is located on a side of the central line. The two sides of the respective pole face that connect the bottom side of the respective pole face to the peak region are non-rectilinear and different from each other in shape.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an exploded perspective view of a conventional stator of a cooling fan.

FIG. 2 is a side view of the conventional stator in FIG. 1.

FIG. 3 is an exploded perspective view of a first embodiment of a stator in accordance with the present invention.

FIG. 4 is a sectional view of the stator in FIG. 3.

FIG. 5 is a sectional view similar o FIG. 4, illustrating a second embodiment of the stator in accordance with the present invention.

FIG. 6 is a sectional view similar to FIG. 4, illustrating a third embodiment of the stator in accordance with the present invention.

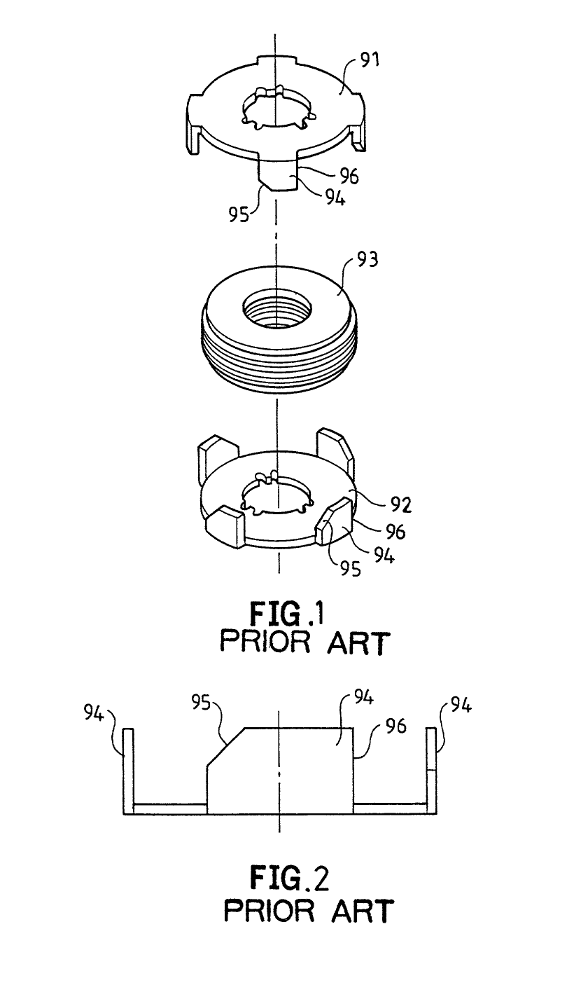

### DETAILED DESCRIPTION OF THE PREFERRED EMBODIMENTS

Preferred embodiments in accordance with the present invention will now be described with reference to the accompanying drawings.

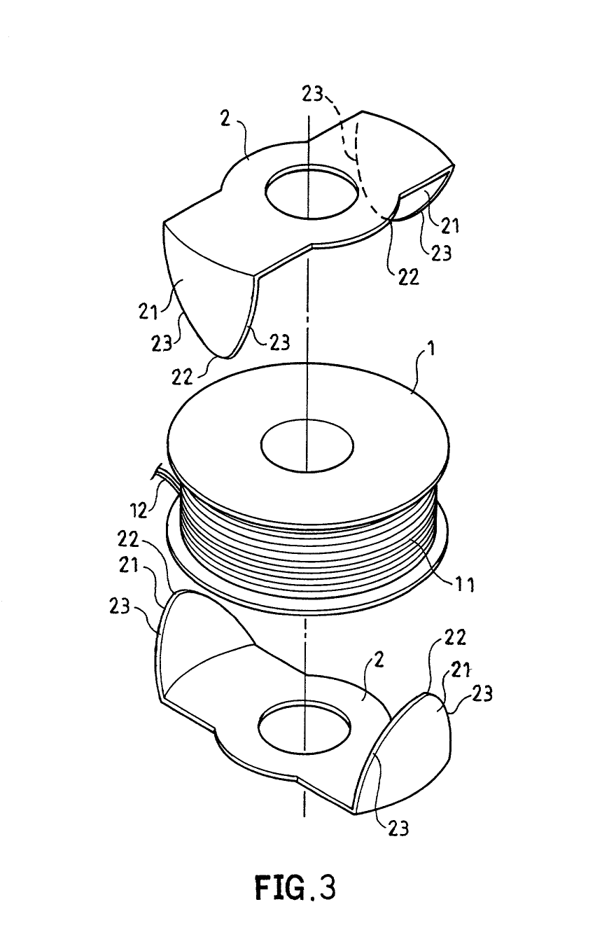

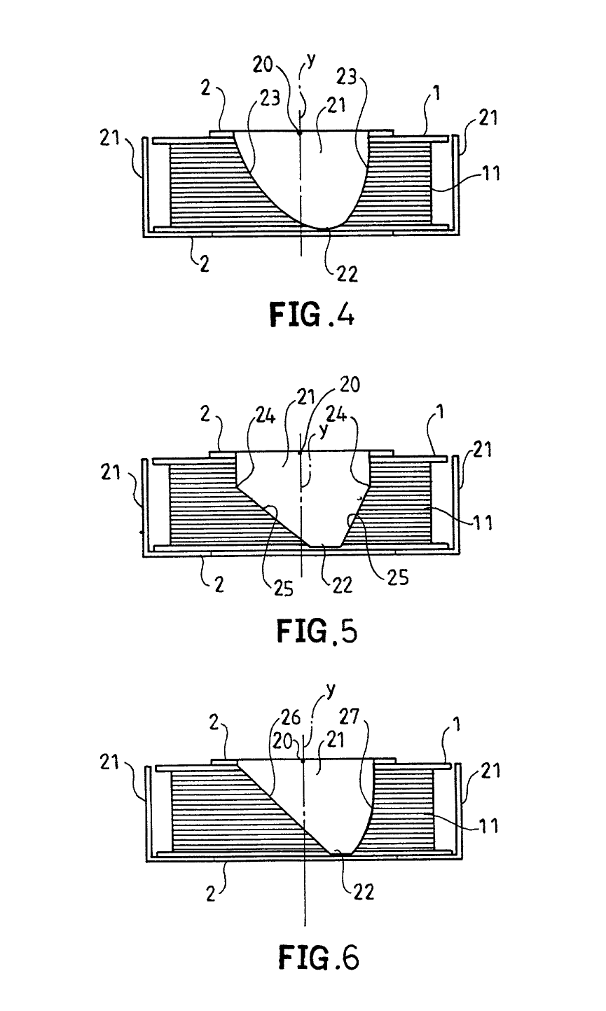

Referring to FIGS. 3 and 4, a first embodiment of a stator for a brushless d.c. motor in accordance with the present invention generally includes a bobbin 1 and at least two pole plates 2. A winding 11 is wound around the bobbin 1 and includes terminals 12 for electrical connection to a power source.

The pole plates 2 are made of magnetically conductive material and, in this embodiment, at least two pole plates 2 are respectively mounted to two ends of the bobbin 1. Each pole plate 2 on an end of the bobbin 1 comprises a plurality of vertically extending pole faces 21. Each pole plate 2 on the other end of the bobbin 1 comprises a plurality of vertically extending pole faces 21 that extend toward the pole faces 21 of the pole plates 2 on the end of the bobbin 1. The pole faces 21 of the pole plates 2 are alternately disposed around the bobbin 1.

Each pole face 21 extends in a plane perpendicular to a general plane of the respective pole plate 2 and comprises a peak region 22 and two sides 23 that meet at the peak region 22. As illustrated in FIG. 4, the peak region 22 is not located on a central line y passing through a middle point 20 on a bottom side (not labeled) of the respective pole face 21 and being perpendicular to the respective pole plate 2. Namely, the peak region 22 is located on a side of the central line y. The two sides 23 of the respective pole face 21 that connect the bottom side of the respective pole face 21 to the peak region 22 are non-rectilinear. In this embodiment, the two sides 23 of the respective pole face 21 are curved sides that are different from each other in shape, best shown in FIG. 4. Thus, no dead corner exists when the permanent magnet comprising alternately disposed north poles and south poles and the pole faces 21 with curved sides 23 induct each other. The cogging torque during rotation of the rotor is less significant, and the trembling problem of the rotor as a result of the cogging torque barely occurs.

FIG. 5 depicts a second embodiment of the stator in accordance with the present invention. In this embodiment, each pole face 21 comprises a peak region 22 and two sides 25 that meet at the peak region 22. The peak region 22 is not located on a central line y passing through a middle point 20 on a bottom side (not labeled) of the respective pole face 21 and being perpendicular to the respective pole plate 2. The two sides 25 of the respective pole face 21 that connect the bottom side of the respective pole face 21 to the peak region 22 are angled. In this embodiment, the two angled sides 25 of the respective pole face 21 have different angles and different lengths. Thus, no dead corner exists when the permanent magnet comprising alternately disposed north poles and south poles and the pole faces 21 with curved sides 23 induct each other. The cogging torque during rotation of the rotor barely occurs, and the trembling problem of the rotor as a result of the cogging torque is reduced.

FIG. 6 depicts a third embodiment of the stator in accordance with the present invention. In this embodiment, each pole face 21 comprises a peak region 22 and two sides 26 and 27 that meet at the peak region 22. The peak region 22 is not located on a central line y passing through a middle point 20 on a bottom side (not labeled) of the respective pole face 21 and being perpendicular to the respective pole plate 2. The side 26 and the side 27 of the respective pole face 21 that connect the bottom side of the respective pole face 21 to the peak region 22 are inclined and arched, respectively. Thus, no dead corner exists when the permanent magnet comprising alternately disposed north poles and south poles and the pole faces 21 with curved sides 23 induct each other. The cogging torque during rotation of the rotor is less significant, and the trembling problem of the rotor as a result of the cogging torque is reduced.

In the pole plate structure of the stator in accordance with the present invention, a peak zone is provided on each of a plurality of pole faces of the two pole plates on the ends of the bobbin, which pole faces of the pole plates on the two ends of the bobbin extend toward each other in a plane perpendicular to a general plane of the respective pole plate. Each pole face has a peak region and two sides. The peak region is not located on a central line passing through a middle point on a bottom side of the respective pole face and being perpendicular to the respective pole plate. The two sides of the respective pole face that connect the bottom side of the respective pole face to the peak region are non-rectilinear and different from each other in shape. Namely, the two sides of the respective pole face may be two curved sides, two angled sides of different angles, or an inclined side and an arched side. Thus, the cogging torque during rotation of the rotor is less significant, and the trembling problem of the rotor as a result of the cogging torque is reduced.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A stator of a motor, comprising:
a bobbin with a winding wound therearound and having two ends; and
two pole plates respectively mounted to the ends of the bobbin, each said pole plate including a plurality of pole faces extending in a plane perpendicular to a general plane of the respective pole plate, each said pole face having a peak region, the peak region being not located on a central line that passes through a middle point on a bottom side of the respective pole face and that are perpendicular to the respective pole plate.

2. The stator for a motor as claimed in claim 1, wherein each said pole face has two sides that meet at the peak region, the two sides of the respective pole face connecting the bottom side of the respective pole face to the peak region and being non-rectilinear and different from each other in shape.

3. The stator for a motor as claimed in claim 2, wherein one of the two sides of the respective pole face is a curved side.

4. The stator for a motor as claimed in claim 2, wherein one of the two sides of the respective pole face is an angled side.

5. The stator for a motor as claimed in claim 2, wherein one of the two sides of the respective pole face is an inclined side.

6. The stator for a motor as claimed in claim 2, wherein one of the two sides of the respective pole face is an arched side.

7. The stator for a motor as claimed in claim 2, wherein the two sides of the respective pole face are two curved sides with different shapes.

8. The stator for a motor as claimed in claim 2, wherein the two sides of the respective pole face are two angled sides with different angles.

9. The stator for a motor as claimed in claim 2, wherein one of the two sides of the respective pole face is an inclined side and the other is an arched side.
